(19) United States
(12) Patent Application Publication
(10) Pub. No.: US 2009/0012852 A1
(43) Pub. Date: Jan. 8, 2009

(54) DATA MARKETPLACE AND BROKER FEES

(75) Inventors: Charles Brian O'Kelley, New York, NY (US); Adam Roger Pritchard, New York, NY (US)

Correspondence Address: BRINKS HOFER GILSON & LIONE / YAHOO! OVERTURE, P.O. BOX 10395, CHICAGO, IL, 60610, US

(73) Assignee: Right Media, Inc., New York, NY (US)

(21) Appl. No.: 11/772,965

(22) Filed: Jul. 3, 2007

(51) Int. Cl. G06Q 30/00

(52) U.S. Cl. 705/14

(57) ABSTRACT

In an advertising serving exchange or network, in one aspect, the invention features a computer-implemented method that includes enabling a data provider to provide a content-request tracking token that associates cookie information with a user when the user visits a website. The method also includes allowing, by the data provider, at least one business entity transacting in a common domain to perform an action based on the cookie information when the user subsequently accesses the webpage. The method can also include selecting an advertisement from one of a plurality of advertisers to be placed on a webpage based on the action. In some arrangements, the data provider passes a share of the proceeds back to the website that supplied the information (e.g., the website on which the pixel was placed).

### BACKGROUND

This description relates to open media exchange platforms.

Electronic exchanges, including online auctions, have proliferated along with the Internet. These electronic exchanges aim to provide a high degree of trading efficiency by bringing together a large number of buyers and sellers. Such centralized exchanges are focused on directly matching the bids/offers of buyers and sellers, and do not recognize or account for pre-existing relationships or agreements with other exchanges or between parties to the transaction, such as between (i) buyers and sellers, (ii) intermediaries (e.g., brokers, which may be a buyer or seller), or (iii) buyers or sellers and intermediaries.

The proliferation of Internet activity has also generated tremendous growth for advertising on the Internet. Typically, advertisers (i.e., buyers of ad space) and online publishers (sellers of ad space) have agreements with one or more advertising networks (ad networks), which provide for serving an advertiser's banner or ad across multiple publishers, and concomitantly provide for each publisher having access to a large number of advertisers. Ad networks (which may also manage payment and reporting) may also attempt to target certain Internet users with particular advertisements to increase the likelihood that the user will take an action with respect to the ad. From an advertiser's perspective, effective targeting is important for achieving a high return on investment (ROI).

Online advertising markets display inefficiencies when buyers and sellers are unable to transact. For instance, although a publisher may be subscribed to many ad networks, and one or more of those ad networks may transact inventory with other ad networks, only one of the ad networks to which the publisher is subscribed will be involved in selling (e.g., auctioning) a given ad space for the publisher. The publisher, or a gatekeeper used by the publisher, selects or prioritizes which ad network (or advertiser having a direct agreement with the publisher) will serve the impression for a given ad request. Thus, the number of buyers for a given ad request is limited and, similarly, advertisers have limited access to ad requests.

### SUMMARY

In an advertising serving exchange or network, in one aspect, the invention features a computer-implemented method that includes enabling a data provider to provide a content-request tracking token that associates cookie information with a user when the user visits a website. The method also includes allowing, by the data provider, at least one business entity transacting in a common domain to perform an action based on the cookie information when the user subsequently accesses the webpage.

Implementations of the invention may include one or more of the following.

The method can include enabling an advertiser to establish targeting rules. Allowing the at least one business entity to perform the action based on the cookie information can include determining a particular action to be performed based on the established targeting rules. For example, the method can also include selecting an advertisement from one of a plurality of advertisers to be placed on a webpage based on the action. Allowing the at least one business entity to perform the action based on the cookie information can include increasing or decreasing an amount of a bid of an advertiser for the advertisement based on the cookie information. Alternatively, allowing the at least one business entity to perform the action based on the cookie information can include withholding a bid of an advertiser for the advertisement based on the cookie information.

The business entity can be an advertiser or an advertising network. Providing the content request token can include providing a pixel tag on the website. The pixel can include a click re-direct. Providing the content request token can include providing a pixel tag on a toolbar.

The method can also include enabling the data provider to generate a user segment based on a grouping of a plurality of content-request tracking tokens. Allowing the at least one business entity to perform the action based on the cookie information can include allowing the at least one business entity to perform the action based on cookie information associated with the user segment. The method can also include placing the advertisement on the webpage. The method can also include providing a portion of a fee for placing the advertisement on the webpage to the data provider. The subject matter of the advertisement placed on the webpage can be related to the subject matter of the website visited by the user.

Selecting an advertisement from one of a plurality of advertisers can include accounting for a fee charged by the data provider. Accounting for a fee charged by the data provider further can include for multiple advertisers in the plurality of advertisers, determining an amount of a bid from the advertiser for an advertisement placement transaction, for each advertiser in the plurality of advertisers, subtracting the fee charged by the data provider from the amount of the bid to generate a net bid, and comparing the net bids for each advertiser in the plurality of advertisers to identify the one of the advertisers in the plurality of advertisers to execute the advertisement placement transaction with the publisher.

Allowing, by the data provider, the at least one business entity to perform the action based on the cookie information can include providing information the business entity that enables the business entity to interpret the cookie information. Allowing, by the data provider, the at least one business entity to perform the action based on the cookie information can include providing information about the website associated with the cookie information to the business entity.

Other general aspects include other combinations of the aspects and features described above and other aspects and features expressed as methods, apparatus, systems, computer program products, and in other ways.

Other features and advantages will become apparent from the description and the claims.

### DESCRIPTION OF DRAWINGS

FIG. 1 shows a block diagram of an open advertisement exchange environment.

FIGS. 2A, 2B, and 2C each schematically depict an environment in which a transaction management system includes a third party data provider.

FIG. 3 schematically depicts an exchange and other entities that interact with the exchange.

FIGS. 4A and 4B each schematically depict an environment in which a transaction management system includes a third party data provider.

### DETAILED DESCRIPTION

Traditionally, online advertising participants fall into three categories, namely advertisers, publishers, and advertisement (“ad”) networks. Each ad network provides a closed market environment in which advertisers compete against one another to buy impressions that has been allocated by publishers to the ad network. In such a closed market environment, advertisers relinquish buying control to the ad network, which spends the advertiser's budget across whatever inventory it has; likewise, publishers relinquish selling control to the ad network, which determines which advertisers will buy the publisher's inventory based on the ad network's needs and consequently results in an arbitrary determination of an impression's value.

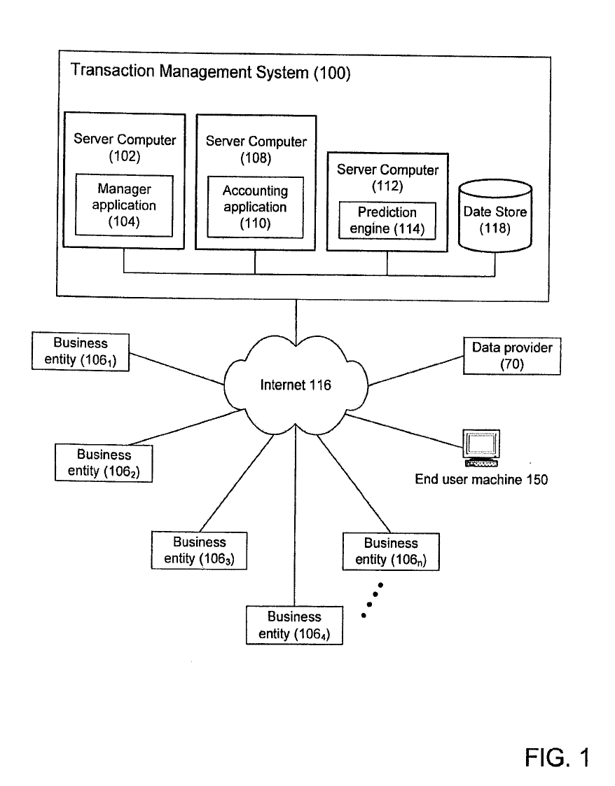

U.S. patent application Ser. No. 11/669,690, entitled “Open Media Exchange Platforms,” filed on Jan. 31, 2007, the contents of which are hereby incorporated by reference in its entirety, describes one implementation of a transaction management system 100 (FIG. 1) that provides a common data and technology platform to connect advertisers, publishers, and ad networks (collectively referred to as “business entities” 106_{1 . . . n}) through the Internet 116 in an open, auction-based market environment (referred to in this description as an “open advertisement exchange”). The transaction management system 100 includes a server computer 102 that runs a manager application 104 to facilitate commercial transactions between business entities 106_{1 . . . n}, a server computer 108 that runs a computer program application (“accounting application” 110) to track and manage accounting activity associated with the commercial transactions, a server computer 112 that runs a computer program application (“prediction engine” 114) to generate one or more predictive metrics for use by the manager application 104 in facilitating a commercial transaction. Such predictive metrics are described in U.S. patent application Ser. No. 11/006,121, entitled “Method and System for Pricing Electronic Advertisements,” filed on Dec. 7, 2004, the contents of which are hereby incorporated by reference in its entirety. The transaction management system 100 also includes a data store 118 (e.g., a database) that stores information provided by the business entities 106_{1 . . . n}.

Pricing for transactions between business entities 106_{1 . . . n} in the open advertisement exchange may be understood to be provided according to any of one or more pricing models, including cost-per-thousand-impressions (CPM), cost-per-click (CPC), cost-per-action (CPA), and may be based on dynamic pricing, pricing based on soft targets, auction-based pricing, ROI goals, and other models. Additionally, in accordance with some embodiments of the transaction management system, business entities 106_{1 . . . n} may upload and update their own pricing models (e.g., proprietary pricing models representing the entity's utility function with respect to ad space, and which may also depend on information about an end user machine), which transaction management system 100 calls upon (e.g., a function call) during the auction process. Further, while the pricing techniques of U.S. patent application Ser. No. 11/006,121 are described in the context of a calculation that involves the probability that a user will take some action (e.g., click probability), the techniques may also be adapted so that such a probability is calculated according to a business entity's own function (e.g., which may be embodied in the business entity's own pricing function).

Given that click probability can differ based on various factors, an advertiser may set targeting rules at an ad campaign level and/or ad creative level to increase the probability that a user will take some action with respect to its inventory. Such targeting rules may specify that creatives of a particular campaign are to be served on particular types of websites and/or to particular types of users. For example, Daimler Chrysler Corporation may specify a set of targeting rules for its “Jeep® Wrangler X” campaign that limits the universe of websites on which creatives may be displayed to outdoor lifestyle-type websites, such as www.camping.com, www.flyfish.com, and www.geocaching.com, and limits the universe of users to which creatives are served to users having characteristics indicative of an outdoor lifestyle type (e.g., historical conversion actions taken by the user with respect to camping-related magazine subscriptions, frequent navigation to online stores that sell fly fishing equipment, and information that suggests the user exhibits behavior of a male between the ages of 18-25).

In a conventional closed market environment, an ad network may place a pixel on a webpage of a first participating publisher (e.g., “publisher M”). The pixel is a tag that has an identification code associated with it. When a user navigates to the webpage on which the pixel is located, a cookie associated with the user is populated with the identification code. Subsequently, when the user navigates to a webpage of another publisher (e.g., “publisher N”) within the closed market environment, the ad network uses the identification code within the cookie in conjunction with targeting rules specified by advertisers to identify ads that are suitable for display on the webpage of publisher N. The publisher M earns pixel-related revenue in those instances in which the user takes an action with respect to the displayed targeted ad.

In the open market environment, a unique opportunity arises for expanding the world of open ad exchange market participants to include third party data providers 70. Unlike business entities 106_{1 . . . n} that buy and sell impressions on the open ad exchange, these third party data providers 70 buy and sell information that enables business entities 106_{1 . . . n} to enhance their market and/or financial position on the open ad exchange. Such information (as described in more detail below) may represent some common characteristic that may be of interest to the business entities 106_{1 . . . n} in defining targeting rules that increase the probability that a user will take some action with respect to its inventory.

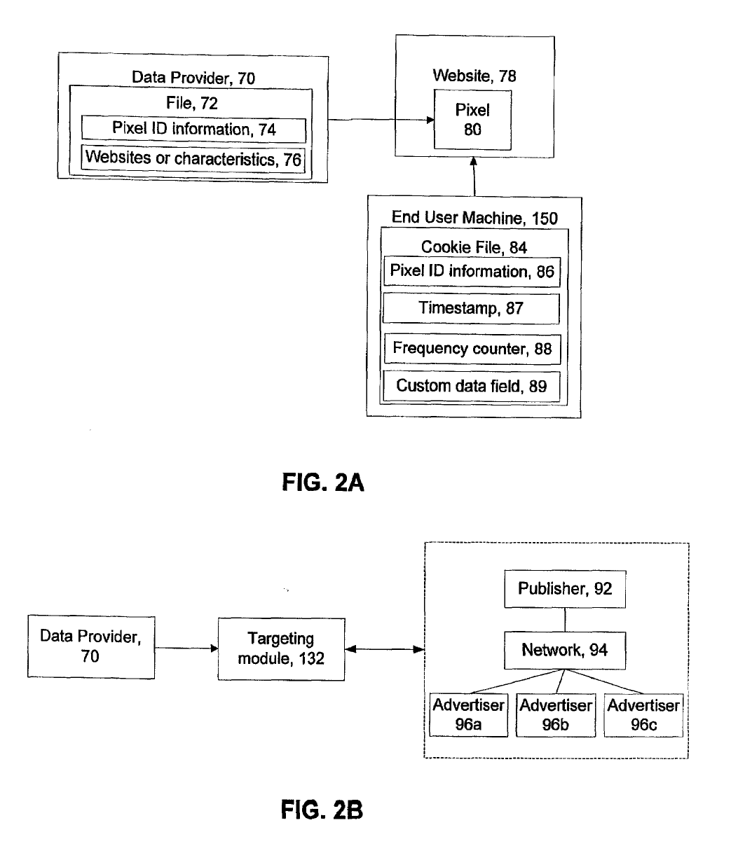

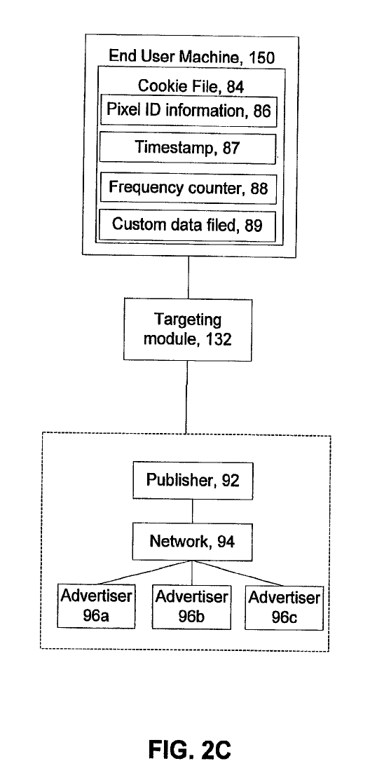

In one embodiment, as shown in FIG. 2A, the data provider 70 receives permission from the owner of a website 78 to place a pixel 80 on the website 78. In general, a pixel is a tag placed on certain pages of a website, on a tool bar, or as a click re-direct, that sets a cookie at the user's computer when the user accesses the webpage. The pixel 80 has a unique identification code (e.g., a numeric code or alphanumeric code) associated with it. In the example of a pixel placed on a webpage, when an end user machine 150 accesses the webpage 78 on which the data provider 70 has placed the pixel 80, the pixel 80 generates an entry in a cookie file 84 on the end user machine 150. The entry in the cookie file 84 includes the pixel identification information 86 and timestamp information 87. The pixel identification information 86 identifies the end user machine 150 as having visited the particular website 78 and the timestamp 87 records the time at which the website 78 was accessed. The cookie file 84 can also include a frequency counter 88 and a custom data field 89. The frequency counter 88 records how often the end user machine 150 has seen the pixel 80. The custom data field 89 can be used by the data provider 70 to set or record additional information. The third party data provider 70 can have arrangements with multiple entities associated with different websites to place pixels on the webpages, tool bars, or click re-directs and to allow the third party data provider 70 to generate cookies.

The data provider 70 maintains a file 72 that associates pixel identification information 74 (e.g., a record of the pixel identification information stored in the user's cookie 84 when the end user machine 150 accesses the website 78 that includes the pixel 80) with websites or characteristics of the website. For example, the data provider 70 can maintain a list of information identifying the pixels that have been placed on various websites and the name of the company or organization associated with each pixel.

In another example, the data provider 70 can maintain a list of information identifying a multiple pixel identification codes that are associated with a particular characteristic of the websites on which the pixels are placed. Since the data provider 70 establishes relationships with multiple websites that allow the data provider 70 to generate cookies, large sets of target users can be tracked from multiple web sites. The data provider 70 can group multiple pixel identification codes associated with websites that have a common characteristic into a ‘user segment.’ A user segment is a grouping of pixel identification codes that identify users that share a common characteristic. Exemplary user segments can include users from a particular geographic region, users of high-end consumer products, users who have previously visited the webpage, sports fans, and fashion enthusiasts. The data provider 70 can sell a list of pixel identification codes that are associated with the segment to one or more business entities 106_{1 . . . n} on the open ad exchange.

For example, the data provider 70 can generate a segment that identifies users that are likely to be car buyers by placing pixels on websites related to cars. To generate such a segment, the third party data provider 70 could place pixels on various automobile related websites such as New York Times Autos, Edmunds.com and Yahoo! Autos. The third party data provider 70 can aggregate the pixel identification information from the pixels placed on the different websites to generate the automotive segment. The third party data provider 70 could sell such an “automotive” segment to any advertiser wanting to reach such an audience by providing the pixel identification information for segment. In the event a lead is generated based on recognition of the pixel identification information on a end user machine 150, the third party data provider 70 gets paid by the party that used the information to target the advertisement. In some arrangements, the third party data provider 70 passes a share of the proceeds back to the website that supplied the information (e.g., the website on which the pixel was placed).

In another example, the data provider 70 can generate a user segment by placing pixels having the same pixel identification code on multiple, different websites. For example, the data provider 70 can generate a segment that identifies users that are likely to purchase sporting goods. The data provider 70 could assign a single pixel identification code to the sporting goods segment. Multiple pixels with this pixel identification code could be placed on different websites such as si.com, msn.foxsports.com, www.ncaasports.com, cbs.sportsline.com. Since the same pixel identification code is placed into the cookie on the end user machine 150 for a user that visits any one of these websites, the data provider 70 does not track the particular website visited by the end user machine 150. Rather the data provider 70 can provide general information about the type of websites visited by the end user machine 150. In this example, the data provider 70 would know that the user had visited some sports-related website.

FIG. 2B shows an interaction between the data provider 70 and at least one entity in a transactor (e.g., at least one of the advertiser, network, or publisher) in a network or exchange). The data provider 70 provides information to the manager application 106 about the websites or user segments associated with the pixel identification information 86 placed in the cookie on the end user machine 150 for users that have visited websites 78 that include pixels 80 placed by the data provider 70. The data provider 70 can charge a fee for providing the information or can charge a fee upon use of the information by the advertiser, network, or publisher. Based on the type of users the advertiser desires to target, the entity in the transactor (e.g., the advertiser) can establish targeting rules (as described below). The targeting rules in combination with information from the data provider 70 about the identification of pixel identification codes can be used by the manager application 106 to match end user machines 150 that have particular pixel identification codes stored in their cookies with the targeting rules set by the advertisers.

As shown in FIG. 2C, when the same end user machine 150 subsequently visits the website of the publisher 92, the manager application 106 reads the pixel identification information 86 included in the cookie file 84 on the end user machine 150 and uses the information provided by the data provider 70 to interpret the pixel identification information 86. The manager application 106 determines if the pixel identification information 86 included in the user's cookie file 84 matches one or more of the targeting rules set by an advertiser 96a, 96b, and/or 96c. If the manager application 106 determines that a match exists, based on this information, the advertiser 96a, 96b, and/or 96c can take an appropriate action with respect to placing or not placing an advertisement on the publisher's website. For example, the information can be used to target placement of an advertisement from one of the advertisers 96a, 96b, and/or 96c onto the publisher's website by placing an advertisement when the pixel identification information 86 identifies the end user machine 150 as having visited a particular website or type of website that might make the user of the end user machine 150 more likely to act on the advertisement or by withholding placement of an advertisement if the end user machine 150 has other characteristics that make the user of the end user machine 150 less likely to act on the advertisement. In other examples, an advertiser could alter (e.g., increase or decrease) an amount of a bid for the advertisement placement based on the information. For example, if the end user machine 150 is identified as having visited a particular website in the past based on the pixel identification information 86 in the cookie file 84 on the end user machine 150, then the advertiser could increase a bid by a set amount, e.g., $0.50.

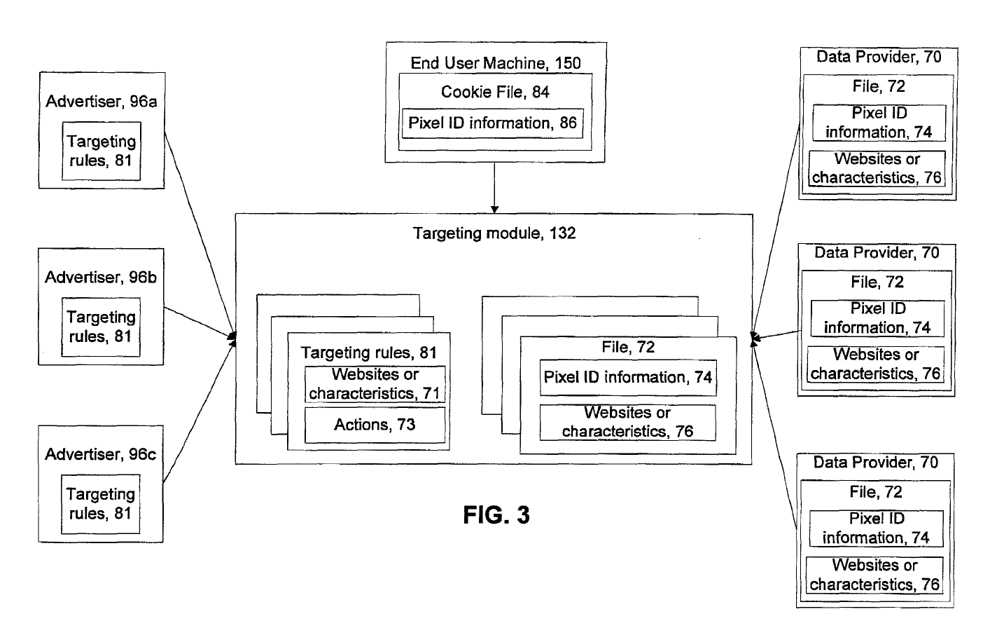

FIG. 3 shows the role of the manager application 106 in the transaction management system 100 in targeting advertisements based on the pixel identification 86 included in the cookie file 84 on an end user machine 150. The data provider(s) 70 provides information 72 to the manager application 106 that relates the pixel identification information 86 to particular websites visited by the end user machine 150 or possible interests of the user (e.g., identifies the user as being part of a particular segment). This information includes the pixel identification information 74 and the related websites, segments, or characteristics 76.

The advertisers 96a, 96b, and/or 96c or other entities that desire to target advertisements based on past activities of an end user machine 150 provide a list of targeting rules 81 to the manager application 106. The targeting rules 81 include information about websites, segments, or characteristics 71 that the advertiser would like to target and associated actions 73 to be taken if a user fits the targeting rule. The manager application 106 uses the information from the data providers 70 and the targeting rules 81 to match the characteristics, segments, or websites 71 that an advertiser desires to target with the pixel identification codes that appear in a cookie file 84 of the end user machine 150.

The actual correlation between the pixel identification information 74 and the website, segment, or characteristic is not shared with the advertiser directly. Rather, the manager application 106 uses the information to match an end user machine 150 having the desired characteristics with the targeting rules 81 provided by the advertisers. For example, the manager application 106 can determine if the cookie file 84 on the end user machine 150 includes any of the pixel identification codes provided by the data providers 70. If the cookie file 84 does include one or more such pixel codes, the manager application 106 can determine the websites, segments, or characteristics associated with the pixel identification information 86. The manager application 106 can also determine if the websites, segments, or characteristics associated with the end user machine 150 (based on the pixel codes) are the subject of any targeting rules 81 for the advertisers. If a match exists, the manager application 106 provides information to the advertiser to allow the advertiser to take action based on the match between the advertisers' targeting rules 81 and the pixel identification information 86 stored on the end user machine 150. In general, the manager application 106 uses the targeting rules 81 from the advertisers to target advertisements only for entities that have a relationship (e.g., a financial agreement) with the data provider 70.

Using a third party data provider 70 to collect and distribute information used by advertisers 96a, 96b, and/or 96c to target placement of advertisements can provide various advantages. Since the third party data provider 70 establishes relationships with multiple entities that allow the data provider 70 to place a pixel 80 on their websites, the advertisers 96a, 96b, and/or 96c and publisher 92 can focus on their core businesses and leave the collection of data used for optimization of advertisement placement to the third party data provider 70.

In some arrangements the third party data provider 70 provides a portion of the revenue to the entity that allows the third party data provider 70 to place the pixel 80 on their website such that the pixel 80 generates the cookie 84 on the end user machine 150 when the user accesses the entity's website. In such arrangements, owners of websites can earn revenue from leads even when the user is not looking at their website, as long as it was their data that led to the user being targeted.

For example, referring again to FIG. 2C, assume that advertisers 96b and 96c sign up or register to use targeting information from data provider 70 and advertiser 96a does not. When an end user machine 150 accesses the website of the publisher 92, the manager application 106 accesses the pixel identification information 86 set in the cookie file 84 on the end user machine 150. The manager application 106 uses the targeting rules 81 provided by advertisers 96b and the pixel identification information 86 to determine if the pixel identification information 86 on the end user machine 150 matches one or more of the targeting rules 81 established by the advertiser. If manager application 106 determines that the subject matter of the advertisement for placement by one of advertisers 96b or 96c is related to the subject matter of the website or segment identified by the pixel identification information 86, the likelihood that the user of the end user machine 150 will take action on the advertisement placed on publisher 92 may be increased. Since the likelihood of the user acting on the advertisement is greater, the bids of the advertisers 96b and 96c will likely be increased due to the presence of the user information from the third party data provider 70. If the advertisement is placed by either advertiser 96b or 96c, data provider 70 will receive revenue from the winning one of advertiser 96b and 96c for providing information used to associate the pixel identification information 86 in the user's cookie file 84 with a characteristic of the end user machine 150. In addition, the publisher 92 will receive revenue for showing the actual advertisement on the page. In some embodiments, the transaction management system 100 which includes the manager application 106 that performs the matching will also receive revenue for performing the matching of the targeting rules 81 to the information about the end user machine 150. If the advertisement is placed by an advertiser who is not using information from the third party data provider 70 (e.g., advertiser 96a), the publisher will receive revenue for showing the advertisement, but the third party data provider 70 will not receive payment.

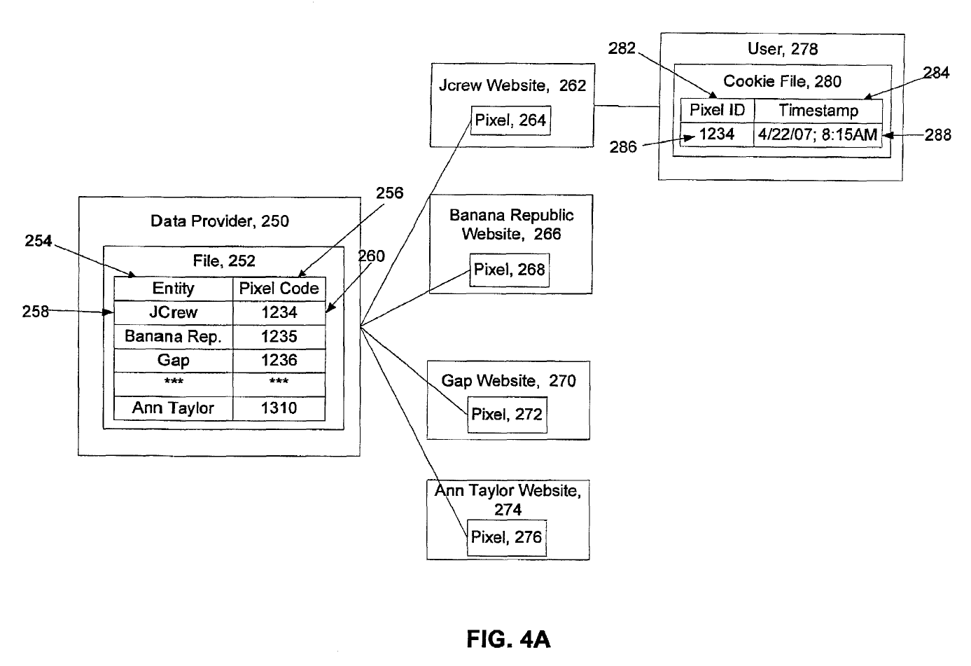

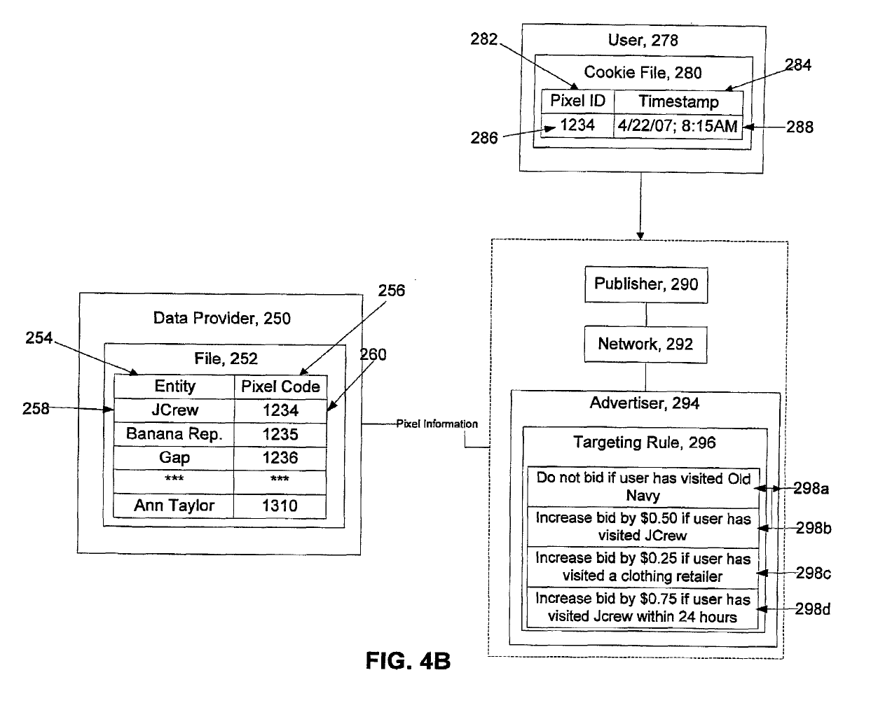

FIGS. 4A and 4B provide an example of use of information from a third party data provider 250 for targeting placement of an advertisement. Referring to FIG. 4A, the data provider 250 receives permission from the owners of multiple websites to place pixels on their webpages. In this example, the data provider 250 has placed a pixel 264 on the JCrew website 262, a pixel 268 on the Banana Republic website 266, a pixel 272 on the Gap website 270, and a pixel 276 on the Ann Taylor website 274. The data provider 250 maintains a file 252 that associates the identity of the website (as shown in column 254) with the pixel identification code (as shown in column 256) that will be placed in a user's cookie file 280 by the pixel. As shown in row 258 of file 252, JCrew is associated with a pixel identification code of ‘1234.’ As such, when a user 278 visits the JCrew website 262, the pixel 264 on the JCrew website 262 places an entry in the user's cookie file 280 that includes the pixel identification code (as shown in column 282) and timestamp information (as shown in column 284). Based on the user's visit to the JCrew website 262, an entry 286 will be added to the user's cookie file 280 with the pixel code of ‘1234’ (as shown in block 286) and timestamp information indicating the time of the visit (as shown in block 288).

Referring to FIG. 4B, an advertiser 294 can generate targeting rules 296 that are used to target advertisements based on cookie information for a user 278 that visits a publisher's website. In this example, the advertiser 294 has established a targeting rule 298a that the advertiser does not wish to bid to place an advertisement on a publisher's website if the user visiting the publisher's website has previously visited Old Navy's website. The advertiser has also generated a targeting rule 298b that increases the bid for an advertisement if the user has visited the JCrew website and a targeting rule 298c that increases the bid for an advertisement if the user has visited any clothing retailer. Targeting rules can also use the timestamp information recorded in the user's cookie file 280. For example, targeting rule 298d increases the bid for an advertisement if the user has visited the JCrew website within the past 24 hours. The advertiser 294 provides the targeting rules 296 to the targeting module in the transaction management system.

The data provider 250 provides information to the a targeting module (not shown) in a transaction management system that enables the targeting module to correlate the pixel identification information stored in a cookie 280 for a user 278 that visits the publisher's website with the websites or types of websites previously visited by the user 278. Since the targeting module possesses information about the identity of the pixels as well as the targeting rules 296 of the advertiser 294, the targeting module can determine whether or not a match exists between the targeting rules 296 of the advertiser 294 and the pixel identification codes 286 stored in a user's cookie file 280. In this example, user 278 visits the website of publisher 290. Since user 278 had previously visited the JCrew website 262, the user has pixel identification information of ‘1234’ for JCrew stored in the cookie file 280. The targeting module reads information from the cookie file 280 and, based on information provided by the data provider 250, the targeting module determines that the pixel identification information indicates that the user 278 has previously visited the website of JCrew. According to the advertiser's targeting rules 296, the targeting module enables the advertiser 294 to take action based on this information by increasing the bid for placement of the advertisement on the publisher's webpage by either $0.75 if the timestamp 288 associated with the pixel identification code 282 shows that the user 278 visited the JCrew website in the last 24 hours or by $0.50 if the user 278 visited the JCrew website but not within in the last 24 hours (based on rules 298d and 298b, respectively).

The accounting and allocation of fees based on the use of information from a third party data provider impacts both bidding and reporting. In general, the bid is based on both the amount an advertiser pays per advertisement acted on by the user and a probability that the advertisement will be acted upon. The value of the advertiser's bid is augmented to reflect the increased likelihood that the advertisement will be acted on based on the targeting information provided in the user data received from the third party data provider. This augmentation of the bid is performed dynamically at the time of the impression, to yield the maximum amount the advertiser is willing to pay for the impression. In addition, the value of the bids that use the information provided by the third party data provider are reduced by the amount of any fee due to a third party data provider. The reduction of the bid for payment of fees to the third party data provider is performed at the time of impression, since the presence (or absence) of such fees among competing bidders could alter which advertiser ultimately wins an auction and for how much. Post-auction, actual payouts of the various fees are tracked. For example, if an advertiser is set up to pay per click, fees should be triggered and collected for such actions when they occur. The accounting application in the transaction management system tracks the fee from the advertiser or publisher to the third party data provider. In addition, in arrangements where the third party data provider provides a payment to the website owner where the information was collected, the system captures payments due from third party data providers to the website owner.

For example, a system can be arranged where an advertiser pays a data provider for impressions that benefit from their targeting expertise (e.g., impressions that benefit from knowing a characteristic associated with a pixel identification code). In such a system, the advertiser that wins a bid to place an advertisement on a publisher's website pays the publisher for right to place the advertisement on publisher site. The advertiser also pays the data provider for use of the targeting information about the user. In addition, the data provider pays the publisher whose data was used to facilitate the placement of the advertisement for the use of their user targeting data. The payments between entities are summarized below in table 1.

TABLE 1

| Entity | Obligations |
|---|---|
| Advertiser | Pays publisher for right to show ad on publisher site |
| | Pays data provider for user targeting data |
| Data provider | Pays publisher for use of their user targeting data |
| Website owner | Makes user data available to data provider |

In some embodiments, user data can be used for advertisement placement in a system where the price of the winning bid is calculated by determining the second best bid and applying a dynamic CPM price reduction rule, wherein the eCPM (effective price per thousand impressions) price actually paid by an auction winner that offers a dynamic CPM price is the lesser of (i) the winning dynamic price and (ii) the amount that the auction winner would have to pay such that the publisher's revenue will equal the publisher revenue that would result from some amount greater (e.g., 5%, 10%, 25%, 50%) than the second best bid price across the entire auction (i.e., considering all tiers and branching points; considering all line items in the auction). In this regard, the second best bid price means the price bid by a second buyer (i.e., other than the auction winner) in the auction that would result (e.g., accounting for revenue sharing along the path between the second buyer and publisher) in the publisher receiving the second highest revenue compared to the winning bid. It is the bid that would have won the auction but for the winning bid. The amount that the auction winner would have to pay such that the publisher's revenue will equal the publisher revenue that would result from some amount (e.g., 5%, 10%, 25%, 50%) greater than the second best bid price being bid by the second buyer depends on the pricing paths of the auction winner and the second best bidder with respect to the publisher and/or each other.

In auctions where dynamic pricing is used to determine the cost of placement of an advertisement, the third party data provider fees will be used twice per auction. The third party data provider fees will be used when computing maximum bid an advertiser is willing to pay for an impression and when computing the actual winning bid which takes into account any price reduction for dCPM deals.

For example, suppose there are three advertisers interested in a given impression:

| | Line Item | 3^{rd} party | | | |
|---|---|---|---|---|---|
| Advertiser | Pricing | fee (%) | Bid | 3^{rd} party fee ($) | Net bid |
| A1 | $1.00 CPM | 0% | $1.00 | $0.00 | $1.00 |
| A2 | $1.75 dCPM | 10% | $1.67 | $0.17 | $1.50 |
| A3 | $2.00 CPM | 40% | $2.00 | $0.80 | $1.20 |

Also, suppose that price reduction for dCPM deals says winner only has to pay 50% more than they bid over the 2^{nd} place advertiser. This means that A2 wins, but their final actual Net Bid should only be $1.35, shown in the table below:

| | Line Item | 3^{rd} party | | | |
|---|---|---|---|---|---|
| Advertiser | Pricing | fee (%) | Bid | 3^{rd} party fee ($) | Net bid |
| A1 | $1.00 CPM | 0% | $1.00 | $0.00 | $1.00 |
| [symbol] | [symbol] | [symbol] | [symbol] | [symbol] | [symbol] |
| A2 | $1.75 dCPM | 10% | ? | ? | $1.35 |
| A3 | $2.00 CPM | 40% | $2.00 | $0.80 | $1.20 |

Using the determined net bid of $1.35, the system determines what the final Broker Fee and the Gross Bid should be for A2. Since $1.35 must be 90% of the Gross Bid and the Broker Fee should be 10% of the Gross Bid, the system calculates the following numbers for A2:

| | Line Item | 3^{rd} party | | | |
|---|---|---|---|---|---|
| Advertiser | Pricing | fee (%) | Bid | 3^{rd} party fee ($) | Net bid |
| A1 | $1.00 CPM | 0% | $1.00 | $0.00 | $1.00 |
| A2 | $1.75 dCPM | 10% | $1.50 | $0.15 | $1.35 |
| A3 | $2.00 CPM | 40% | $2.00 | $0.80 | $1.20 |

Hence, A2 pays $1.50, the broker fee is $0.15, and the seller earns revenue of $1.35 on this impression. If price reduction is not invoked then the payout is per the first table above. Similar calculations can be applied to CPC/CPA deals, since they ultimately get translated into an eCPM, at which point the broker fee can be factored in prior to the auction. In this case however, payout is based on the actual CPC/CPA only if the user converts; therefore the broker fee should only be earned on conversion.

In the above examples, providing a portion of the broker fee to the data provider for placing the advertisement on the webpage included providing a percentage of the fee. It is appreciated that the portion of the fee provided to the data provider can be in the form of flat fee, sliding scale or any other agreed upon amount.

Although the techniques are described above in the online advertising context, the techniques are also applicable in any number of different open exchanges in which products, commodities or services are offered for purchase or sale.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other embodiments are within the scope of the following claims. The following are examples for illustration only and not to limit the alternatives in any way. The techniques described herein can be performed in a different order and still achieve desirable results.

1. In an advertising serving exchange or network, a computer-implemented method comprising:
enabling a data provider to provide a content-request tracking token that associates cookie information with a user when the user visits a website;
allowing, by the data provider, at least one business entity transacting in a common domain to perform an action based on the cookie information when the user subsequently accesses the webpage.

2. The method of claim 1 wherein allowing the at least one business entity to perform an action includes establishing targeting rules.

3. The method of claim 2 wherein allowing the at least one business entity to perform the action based on the cookie information comprises determining a particular action to be performed based on the established targeting rules.

4. The method of claim 3 wherein determining a particular action includes selecting an advertisement from one of a plurality of advertisers to be placed on a webpage when the user subsequently accesses the webpage.

5. The method of claim 1 wherein allowing the at least one business entity to perform the action based on the cookie information comprises increasing an amount of a bid of an advertiser for the advertisement based on the cookie information.

6. The method of claim 1 wherein allowing the at least one business entity to perform the action based on the cookie information comprises decreasing an amount of a bid of an advertiser for the advertisement based on the cookie information.

7. The method of claim 1 wherein allowing the at least one business entity to perform the action based on the cookie information comprises withholding a bid of an advertiser for the advertisement based on the cookie information.

8. The method of claim 1 wherein the business entity comprises at least one of an advertiser and an advertising network.

9. (canceled)

10. The method of claim 1 wherein providing the content request token comprises providing a pixel tag on the website.

11. The method of claim 10 wherein the pixel includes click re-direct.

12. (canceled)

13. The method of claim 1 further comprising enabling the data provider to generate a user segment based on a grouping of a plurality of content-request tracking tokens.

14. The method of claim 13 wherein allowing the at least one business entity to perform the action based on the cookie information comprises allowing the at least one business entity to perform the action based on cookie information associated with the user segment.

15. (canceled)

16. The method of claim 1 further comprising providing a portion of a fee for placing the advertisement on the webpage to the data provider.

17. The method of claim 16 wherein the subject matter of the advertisement placed on the webpage is related to the subject matter of the website visited by the user.

18. The method of claim 1 wherein selecting an advertisement from one of a plurality of advertisers comprises accounting for a fee charged by the data provider.

19. The method of claim 18 wherein accounting for a fee charged by the data provider further comprises:
for multiple advertisers in the plurality of advertisers, determining an amount of a bid from the advertiser for an advertisement placement transaction;
for each advertiser in the plurality of advertisers, subtracting the fee charged by the data provider from the amount of the bid to generate a net bid; and
comparing the net bids for each advertiser in the plurality of advertisers to identify the one of the advertisers in the plurality of advertisers to execute the advertisement placement transaction with the publisher.

20. The method of claim 1 wherein allowing, by the data provider, the at least one business entity to perform the action based on the cookie information comprises providing information the business entity that enables the business entity to interpret the cookie information.

21. The method of claim 1 wherein allowing, by the data provider, the at least one business entity to perform the action based on the cookie information comprises providing information about the website associated with the cookie information to the business entity.

22. In an advertising serving exchange or network, a computer-implemented method comprising:
receiving information from one or more data providers that associates a characteristic with a pixel identification code;
receiving one or more targeting rules from an advertiser;
determining cookie information associated with a user when the user accesses a website; and
performing an action based on the cookie information, the information from the one or more data providers, and the one or more targeting rules.

23. The method of claim 22 wherein performing the action includes selecting an advertisement from one of a plurality of advertisers to be placed on the website when the user subsequently accesses the website.

24. The method of claim 22 wherein performing the action comprises increasing or decreasing an amount of a bid of an advertiser for an advertisement based on the cookie information.

25. The method of claim 22 wherein performing the action comprises withholding a bid of an advertiser for an advertisement based on the cookie information.

26. The method of claim 22 wherein receiving the information comprises receiving, from the data provider, information associated with a user segment based on a grouping of a plurality of pixel identification codes.

27. (canceled)

28. The method of claim 27 further comprising providing a portion of a fee for placing the advertisement on the website to the data provider.

29. The method of claim 22 wherein the characteristic comprises at least one of a webpage and a segment.

30. (canceled)
